(19) United States
(12) Patent Application Publication
(10) Pub. No.: US 2025/0104592 A1
(43) Pub. Date: Mar. 27, 2025

(54) DRIVER, ELECTRO-OPTICAL DEVICE, AND ELECTRONIC APPARATUS

(71) Applicant: SEIKO EPSON CORPORATION, Tokyo (JP)

(72) Inventors: Ryota BANSHO, Matsumoto-Shi (JP); Akira MORITA, Chino-Shi (JP)

(73) Assignee: SEIKO EPSON CORPORATION, Tokyo (JP)

(21) Appl. No.: 18/895,374

(22) Filed: Sep. 24, 2024

(30) Foreign Application Priority Data
Sep. 27, 2023 (JP) 2023-166273

(51) Int. Cl. G09G 3/20; G09G 3/36

(52) U.S. Cl. CPC G09G 3/2007; G09G 3/2096; G09G 3/3648; G09G 2310/0251

(57) ABSTRACT

A driver including a capacitor circuit, a capacitor driving circuit, a variable capacitance circuit, and a control circuit is provided. The capacitor circuit includes first to n-th capacitors provided between first to n-th capacitor driving nodes and an output terminal. The variable capacitance circuit is connected to the output terminal. The control circuit sets the variable capacitance circuit to the first capacitance value in a pixel driving period of the electro-optical panel, and sets the variable capacitance circuit to the second capacitance value smaller than the first capacitance value in a precharge period of the electro-optical panel.

The present application is based on, and claims priority from JP Application Serial Number 2023-166273, filed Sep. 27, 2023, the disclosure of which is hereby incorporated by reference herein in its entirety.

### BACKGROUND

### 1. Technical Field

The present disclosure relates to a driver, an electro-optical device, an electronic apparatus, and the like.

### 2. Related Art

JP-A-2016-80805 discloses a driver that capacitively drives an electro-optical panel. The driver disclosed in JP-A-2016-80805 includes a capacitor circuit connected to a data voltage output terminal, a capacitor driving circuit for driving the capacitor circuit, and a variable capacitance circuit connected to the data voltage output terminal. The capacitance of the variable capacitance circuit is set to achieve a certain capacitance ratio relationship between a capacitance as a sum of the capacitance of the variable capacitance circuit and the electro-optical panel-side capacitance, and the capacitance of the capacitor circuit.

In order to improve display quality, the driver applies a precharge voltage to a data line before writing data voltage to a pixel. Demultiplex driving, phase expansion driving, and the like have been known as a method in which a plurality of data lines are driven in a time division manner, by one output of a driver. In such a driving method, the one output of the driver is connected to the plurality of data lines at the time of precharge, and is connected to one data line at the time of pixel writing.

According to the capacitive driving in JP-A-2016-80805, the data voltage which is supplied to pixels through charge redistribution, is determined based on the capacitance ratio between the capacitance on the driving side and the capacitance on the panel side. For this reason, a variation in the number of data lines connected to the output of the driver between the precharge and the pixel writing leads to a variation in the capacitance ratio in the charge redistribution resulting in a variation in the range of the data voltage that can be output. Such a problem does not occur only with the precharge and pixel writing and also occurs in any operation state involving the variation in the capacitance ratio. As described above, the capacitive driving involves a problem in that the range of the data voltage varies among operation states.

### SUMMARY

An aspect of the present disclosure relates to a driver including a capacitor driving circuit configured to output first to n-th capacitor driving voltages, corresponding to grayscale data to first to n-th capacitor driving nodes, n being a natural number equal to or larger than 2, a capacitor circuit including first to n-th capacitors provided between the first to n-th capacitor driving nodes and an output terminal, a variable capacitance circuit connected to the output terminal, and a control circuit configured to set the variable capacitance circuit to a first capacitance value in a pixel driving period of an electro-optical panel and to set the variable capacitance circuit to a second capacitance value smaller than the first capacitance value in a precharge period of the electro-optical panel.

Another aspect of the present disclosure relates to an electro-optical device including the above-described driver and the electro-optical panel, wherein the electro-optical panel includes: a signal supply line, first to p-th switches having one ends connected to the signal supply line, p being an integer that is equal to or larger than 2; and first to p-th data lines connected to other ends of the first to p-th switches.

Still another aspect of the present disclosure relates to an electronic apparatus including the driver described above.

### BRIEF DESCRIPTION OF THE DRAWINGS

FIG. 1 illustrates a configuration example of an electro-optical device.

FIG. 2 illustrates a configuration example of a pixel.

FIG. 3 illustrates a detailed configuration example of a driver.

FIG. 4 illustrates a detailed configuration example of a capacitor circuit, a capacitor driving circuit, and a variable capacitance circuit.

FIG. 5 is a diagram illustrating a capacitance related to capacitive driving.

FIG. 6 is a diagram illustrating a configuration example of the driver circuit and a connection relationship between the driver circuit and a capacitance.

FIG. 7 is a diagram illustrating control on a variable capacitance circuit in each operation state.

FIG. 8 illustrates a specific example of a capacitive driving amplitude in a case where the capacitance value of the variable capacitance circuit does not change depending on the operation state.

FIG. 9 illustrates a specific example of the capacitive driving amplitude in a case where the capacitance value of the variable capacitance circuit does not change depending on the operation state.

FIG. 10 illustrates a specific example of the capacitive driving amplitude in a case where the capacitance value of the variable capacitance circuit changes depending on the operation state.

FIG. 11 illustrates a specific example of the capacitive driving amplitude in a case where the capacitance value of the variable capacitance circuit changes depending on the operation state.

FIG. 12 is a diagram illustrating control on the variable capacitance circuit in each operation state in a case where divided precharge is performed.

FIG. 13 illustrates a configuration example of an electronic apparatus.

### DESCRIPTION OF EMBODIMENTS

Embodiments of the present disclosure will be described in detail hereinafter. Note that the present embodiment described hereinafter is not intended to unjustly limit the content of the present disclosure as set forth in the claims, and all of the configurations described in the present embodiment are not necessary essential elements.

### 1. Electro-Optical Device

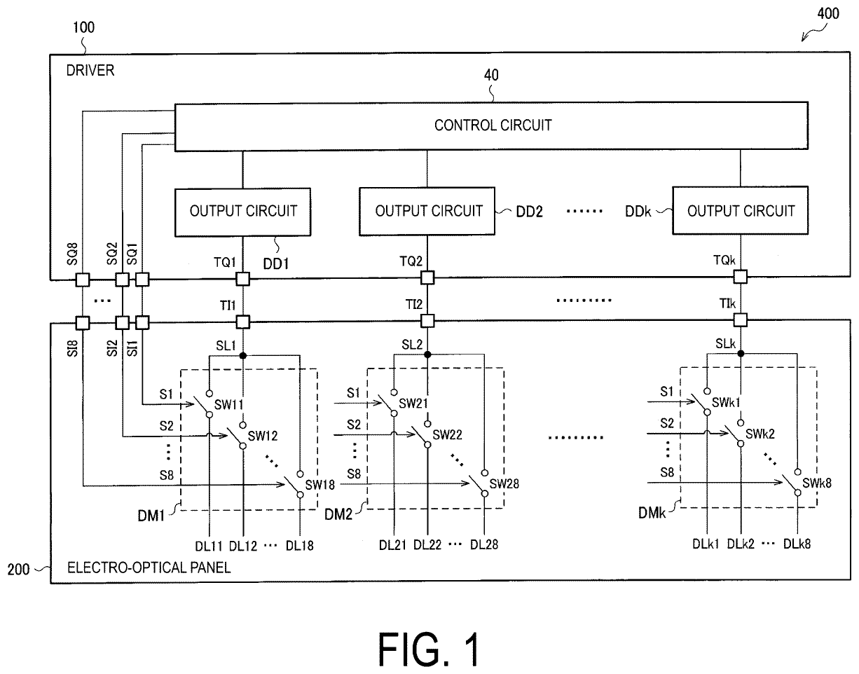

FIG. 1 illustrates a configuration example of an electro-optical device. The electro-optical device 400 includes a driver 100 and an electro-optical panel 200. Hereinafter, the electro-optical device 400 employing demultiplex driving will be described as an example, but the electro-optical device 400 is not limited thereto and may employ phase expansion driving, for example. While an example in which the demultiplexing count is eight will be described below, it suffices if the demultiplexing count is p. p is an integer equal to or larger than 2.

The driver 100 includes a control circuit 40, output circuits DD1 to DDk, output terminals TQ1 to TQk, and control signal output terminals SQ1 to SQ8. k is an integer equal to or larger than 2. The driver 100 is, for example, an integrated circuit device having a plurality of circuit elements integrated on a semiconductor substrate.

The electro-optical panel 200 includes input terminals TI1 to TIk, signal supply lines SL1 to SLk, demultiplexers DM1 to DMk, data lines DL11 to DL18, DL21 to DL28, . . . , DLk1 to DLk8, and control signal input terminals SI1 to SI8. The electro-optical panel 200 is, for example, an active matrix type liquid crystal display panel, an EL display panel using self-luminous element, or the like. EL is an abbreviation of Electro-Luminescence.

The control circuit 40 outputs the corresponding grayscale data to the output circuit DD1. The output circuit DD1 converts the grayscale data into a data voltage and outputs the data voltage to the output terminal TQ1. The output terminal TQ1 is connected to the input terminal TI1, and the input terminal TI1 is connected to the signal supply line SL1. The same applies to the output circuits DD2 to DDk, the output terminals TQ2 to TQk, the input terminals TI2 to TIk, and the signal supply lines SL2 to SLk.

The demultiplexer DM1 includes switches SW11 to SW18. The switches are each, for example, a TFT. TFT is an abbreviation of Thin Film Transistor. The switch SW11 has one end connected to the signal supply line SL1, and the other end connected to the data line DL11. The switch SW11 is controlled to be turned ON or OFF by a control signal S1. Similarly, the switches SW12 to SW18 have one ends connected to the signal supply line SL1, and other ends connected to the data lines DL12 to DL18. The switches SW12 to SW18 are controlled to be turned ON or OFF by control signals S2 to S8. The same applies to the demultiplexers DM2 to DMk, switches SW21 to SW28, . . . , SWk1 to SWk8, and the data lines DL21 to DL28, . . . , DLk1 to DLk8. The number of switches and the number of data lines in each demultiplexer may be p, which is the same as the demultiplexing count.

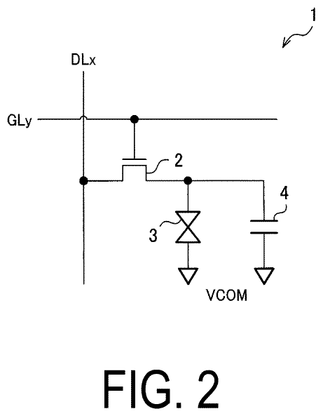

Although not illustrated in FIG. 1, the electro-optical panel 200 has a plurality of pixels arranged in matrix. FIG. 2 illustrates a configuration example of the pixel. A pixel 1 includes a pixel transistor 2, a pixel electrode 3, and a retention capacitor 4. The pixel transistor 2 is, for example, TFT. The pixel transistor 2 has the source connected to a data line DLx and the gate connected to a scanning line GLy. DLx is any of the data lines illustrated in FIG. 1. GLy is any of a plurality of scanning lines provided in the electro-optical panel 200. The pixel electrode 3 includes two electrodes opposite to each other. In a liquid crystal display panel, two electrodes face are provided opposite to each other with liquid crystal interposed therebetween. The pixel electrode 3 and the retention capacitor 4 each have one electrode connected to the drain of the pixel transistor 2, and the other electrodes connected to a node of a common voltage VCOM. The scanning lines are selected by a scanning line driving circuit (not illustrated). The scanning line driving circuit may be included in the driver 100 or may be provided outside the driver 100.

The demultiplex driving will be described using the output circuit DD1 as an example. In one horizontal scanning period, the switches SW11, SW12, . . . , SW18 are sequentially turned ON. When the switch SW11 is ON, the output circuit DD1 writes the data voltage to the pixel connected to the data line DL11. Similarly, when the switches SW12, . . . , SW18 are ON, the output circuit DD1 writes the data voltage to the pixels connected to the data lines DL12, . . . , DL1k. Note that rotation or the like may be implemented in the demultiplex driving, and the switches SW11, SW12, . . . , SW18 may be turned ON in any order. The data voltage is a voltage written to one pixel at one time. With the demultiplex driving, eight pixels are driven in time series, and the data voltage for each of the pixels is output to the signal supply line as a time series signal. This signal will be referred to as a data signal. In the horizontal scanning period, precharge and the like are performed in addition to driving of the pixels, which will be described later.

### 2. Detailed Configuration Example of Driver

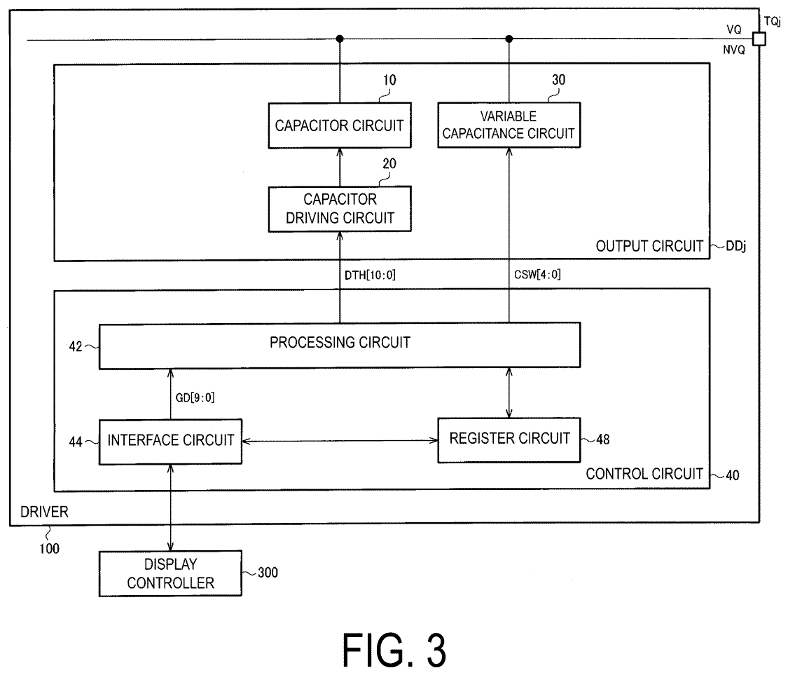

FIG. 3 illustrates a detailed configuration example of the driver. FIG. 3 illustrates an output circuit DDj, which is any one of the output circuits DD1 to DDk, and the control circuit 40. j is an integer equal to or larger than 1 and equal to or less than k. The output circuit DDj includes a capacitor circuit 10, a capacitor driving circuit 20, and a variable capacitance circuit 30. The control circuit 40 includes a processing circuit 42, an interface circuit 44, and a register circuit 48.

The interface circuit 44 executes interface processing between a display controller 300 that controls the driver 100 and the driver 100. The interface circuit 44 outputs grayscale data GD[9:0] received from the display controller 300, to the processing circuit 42. Note that the received grayscale data may have any number of bits. The interface circuit 44 is, for example, an image interface circuit of an LVDS system, a parallel RGB system, a display port system, or the like. LVDS is an abbreviation of Low Voltage Differential Signaling.

The processing circuit 42 outputs grayscale data DTH[10:0] to the capacitor driving circuit 20 based on the grayscale data GD[9:0]. The capacitor driving circuit 20 drives the capacitor circuit 10 based on the grayscale data DTH[10:0]. The capacitor circuit 10 and the variable capacitance circuit 30 are connected to an output node NVQ connected to an output terminal TQj. When the capacitor circuit 10 is driven, charge is injected from the capacitor circuit 10 to the output node NVQ or charge is discharged from the output node NVQ to the capacitor circuit 10. This charge transfer is redistributed to the variable capacitance circuit 30 and the internal capacitance of the electro-optical panel 200, so that an output voltage VQ of the output node NVQ is obtained as a data voltage corresponding to the grayscale data DTH[10:0].

As an example, the common voltage is assumed to be 7.5 V, the voltage range of the positive polarity driving is assumed to be 7.5 V to 12.5 V, and the voltage range of the negative polarity driving is assumed to be 7.5 V to 2.5 V. In this case, DTH[10:0]=000h corresponds to 2.5 V, DTH[10:0]=400h corresponds to 7.5 V, and DTH[10:0]=4FFh corresponds to 12.5 V. When the polarity is not inverted, the grayscale data GD[9:0] may be directly output to the capacitor driving circuit 20.

The register circuit 48 stores setting data CSW[4:0] for setting the capacitance value of the variable capacitance circuit 30. For example, the display controller 300 writes the setting data CSW[4:0] to the register circuit 48 via the interface circuit 44. Alternatively, the driver 100 may include a non-volatile memory (not illustrated) in which the setting data CSW[4:0] is stored in advance, and the setting data CSW[4:0] may be loaded from the non-volatile memory to the register circuit 48.

The processing circuit 42 sets the capacitance value of the variable capacitance circuit 30 by outputting the setting data CSW[4:0] read from the register circuit 48 to the variable capacitance circuit 30. The value of the setting data CSW[4:0] is set for each operation state of the driver 100. In each operation state, the processing circuit 42 outputs the setting data CSW[4:0] corresponding to the operation state to the variable capacitance circuit 30, and makes the capacitance value of the variable capacitance circuit 30 vary between operation states. The operation state includes precharge and pixel driving. In addition, the operation state may further include post charge.

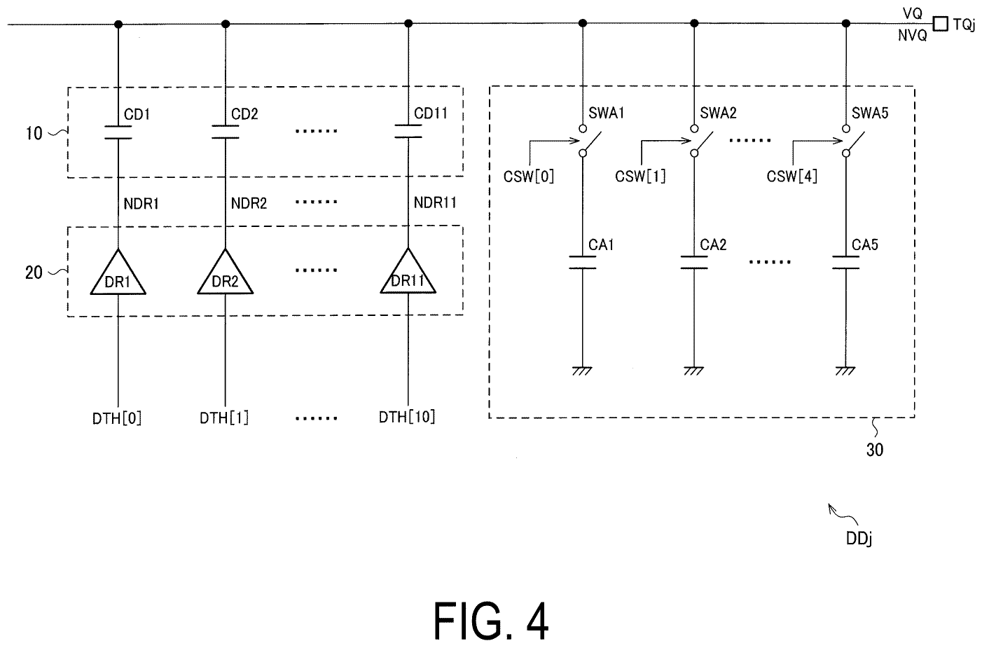

FIG. 4 illustrates a detailed configuration example of the capacitor circuit, the capacitor driving circuit, and the variable capacitance circuit.

The capacitor circuit 10 includes capacitors CD1 to CD11. The capacitor driving circuit 20 includes driving circuits DR1 to DR11. Note that the number of capacitors and drive circuits may be n. n is an integer equal to or larger than 2. Similarly, the number of bits of the grayscale data DTH[10:0] may be n.

A capacitor CDi has one end connected to the output node NVQ, and has the other end connected to a capacitor driving node NDRi. i is an integer equal to or larger than 1 and equal to or less than 11. The capacitors CD1 to CD11 each have a binary weighted capacitance value. Specifically, the capacitance value of the capacitor CDi is 2⁽ⁱ⁻¹⁾×CD1.

The processing circuit 42 outputs an i-th bit DTH[i−1] of the grayscale data DTH[10:0] to an input node of a driving circuit DRi. The driving circuit DRi outputs a capacitor driving voltage corresponding to the logic level of the i-th bit DTH[i−1] to the capacitor driving node NDRi. Specifically, the driving circuit DRi outputs a first voltage level to the capacitor driving node NDRi when a bit DTH[i−1] is at a first logic level, and outputs the second voltage level to the capacitor driving node NDRi when the bit DTH[i−1] is at a second logic level. For example, the first logic level is “0”, the second logic level is “1”, the first voltage level is a low potential side power supply voltage, and the second voltage level is a high potential side power supply voltage. For example, the driving circuit DRi includes a level shifter configured to shift the input logic level to an output voltage level of the driving circuit DRi and a buffer circuit for buffering the output of the level shifter.

When the driving circuits DR1 to DR11 drive the capacitors CD1 to CD11, the charge redistribution occurs among the capacitors CD1 to CD11, the variable capacitance circuit 30, and the electro-optical panel-side capacitance. As a result, the data voltage is written to the pixel.

The variable capacitance circuit 30 includes adjustment switches SWA1 to SWA5 and adjustment capacitors CA1 to CA5. Note that the number of switches and adjustment capacitors may be m. m is an integer equal to or larger than 2.

An adjustment switch SWAs has one end connected to the output node NVQ, and the other end connected to one end of an adjustment capacitor CAs. The other end of the adjustment capacitor CAs is connected to the low potential side power supply. s is an integer equal to or larger than 1 and equal to or less than 5. The adjustment switches SWA1 to SWA6 are, for example, P-type MOS transistors, N-type MOS transistors, or transfer gates. The adjustment capacitors CA1 to CA5 each have a binary weighted capacitance value. Specifically, a capacitance value of the adjustment capacitor CAs is 2^{(s-1)}×CA1.

The adjustment switch SWAs is controlled to be turned ON or OFF by an s-th bit CSW[s−1] of CSW[4:0]. When the adjustment switch SWAs is ON, the adjustment capacitor CAs is connected to the output node NVQ, and the capacitance value of the adjustment capacitor CAs is added to the capacitance value of the variable capacitance circuit 30. Thus, the capacitance value of the variable capacitance circuit 30 is set according to the ON/OFF state of the adjustment switches SWA1 to SWA5.

The output circuit DDj may further include a grayscale voltage generation circuit and an amplifier circuit. The grayscale voltage generation circuit performs D/A conversion on the grayscale data DTH[10:0] and outputs a grayscale voltage corresponding to the grayscale data DTH[10:0]. The grayscale voltage generation circuit includes, for example, a ladder resistor that generates voltages corresponding to respective grayscale values, and a selection circuit that selects a voltage corresponding to the grayscale data DTH[10:0] from the voltages. The amplifier circuit amplifies or buffers the grayscale voltage output from the grayscale voltage generation circuit and outputs the grayscale voltage to the output node NVQ. The amplifier circuit is, for example, a voltage follower circuit. The voltage output by the amplifier circuit is basically the same as the voltage output by capacitive driving.

### 3. Control on Capacitive Driving Circuit

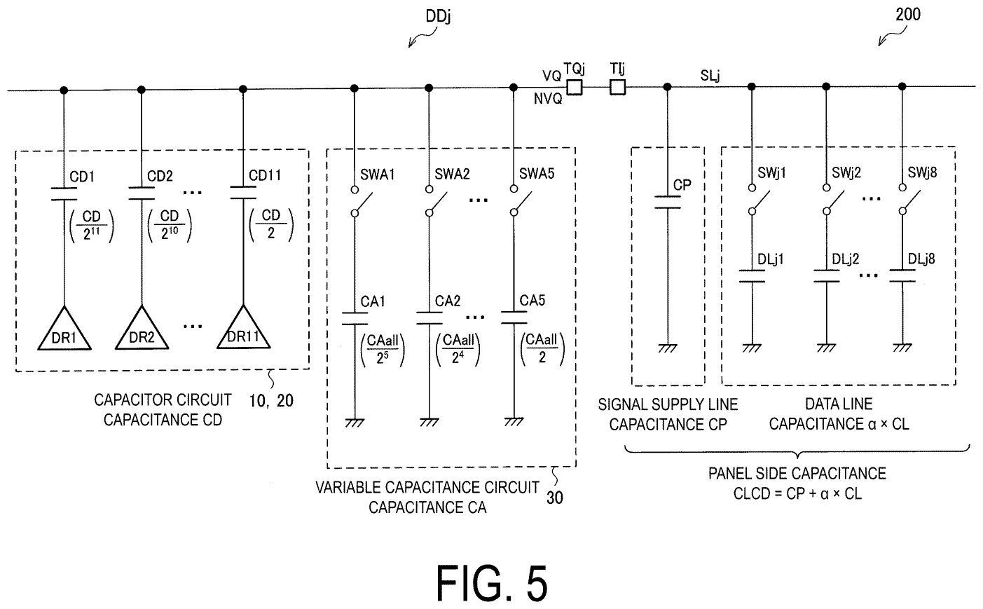

FIG. 5 is a diagram illustrating a capacitance related to the capacitive driving. The illustration of the capacitor driving circuit 20 is simplified.

The capacitance value of the capacitor CDi is CD/2⁽¹²⁻ⁱ⁾, where CD is the total capacitance of the capacitors CD1 to CD11 in the capacitor circuit 10. The capacitance value of the adjustment capacitor CAs is CAall/2^{(6-s)}, where CAall is the total capacitance of the adjustment capacitors CA1 to CA5 in the variable capacitance circuit 30. A capacitance value CA of the variable capacitance circuit 30 is a sum of the capacitance values of the adjustment capacitors connected to the output node NVQ by the adjustment switches SWA1 to SWA5.

A capacitance on the side of the electro-optical panel 200 relative to the output terminal TQj is referred to as an electro-optical panel-side capacitance CLCD. The capacitance value of a signal supply line SLj is defined as CP, and the capacitance value of each of data lines DLj1 to DLj8 is defined as CL. These are parasitic capacitances between the wiring and the substrate or the like. The number of switches that are ON among the switches SWj1 to SWj8 of the demultiplexer is defined as a. Under such definitions, the electro-optical panel-side capacitance is CLCD=CP+α×CL.

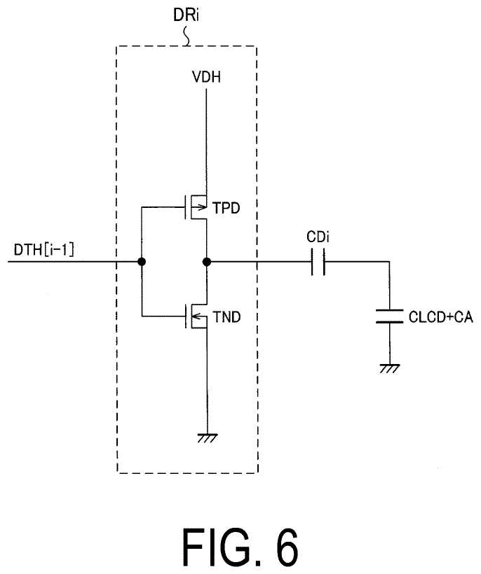

FIG. 6 illustrates a configuration example of the driver circuit and a connection relationship between the driver circuit and a capacitor. Here, the voltage of the low potential side power supply is assumed to be a ground voltage, and the voltage of the high potential side power supply is defined as VDH. While the driving circuit DRi may further include a level shifter or the like, only a buffer portion at the final stage is illustrated herein.

The driving circuit DRi includes a P-type MOS transistor TPD and an N-type MOS transistor TND which are connected to achieve an inverter form. The bit DTH[i−1] is input to the gates of these transistors. The capacitor CDi and a capacitance CLDC+CA are connected in series between the output of the driving circuit DRi and a ground voltage node. The capacitance CLDC+CA is a capacitance in which the electro-optical panel-side capacitance CLCD and the variable capacitance circuit 30 are connected in parallel.

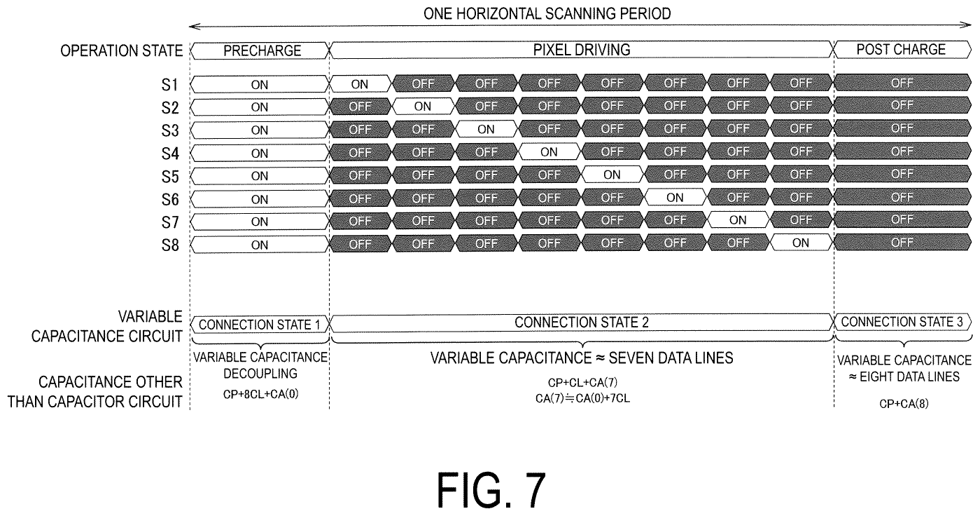

FIG. 7 is a diagram illustrating control on the variable capacitance circuit in each operation state. During the horizontal scanning period, the operation state transitions among precharge, pixel driving, and post charge in this order.

When the operation state is precharge, the control circuit 40 outputs the control signals S1 to S8 indicating ON. As a result, all the switches SWj1 to SWj8 of a demultiplexer DMj are turned ON, and the precharge voltage is applied to all the eight data lines. Since all the eight data lines are connected to the signal supply line SLj, the electro-optical panel-side capacitance is CLCD=CP+8CL. Note that a period in which the precharge is performed in the horizontal scanning period is referred to as a precharge period.

When the operation state is pixel driving, the following control is performed. The control circuit 40 outputs the control signal S1 indicating ON, and outputs the control signals S2 to S7 indicating OFF. Accordingly, the switch SWj1 of the demultiplexer DMj is turned ON, and the switches SWj2 to SWj8 are turned OFF. Similarly, the control circuit 40 sequentially outputs the control signals S2, . . . , S8 indicating ON. The data voltage is applied to each data line, and the data voltage is written to a pixel connected to the data line. Since one data line is connected to the signal supply line SLj, the electro-optical panel-side capacitance is CLCD=CP+CL. Note that a period in which pixel driving is performed in the horizontal scanning period is referred to as a pixel driving period.

When the operation state is post charge, the control circuit 40 outputs the control signals S1 to S8 indicating OFF. Accordingly, all the switches SWj1 to SWj8 of the demultiplexer DMj are turned OFF. Since all the eight data lines are connected to the signal supply line SLj, the electro-optical panel-side capacitance is CLCD=CP. Note that a period in which the post charge is performed in the horizontal scanning period is referred to as a post charge period.

The variable capacitance circuit 30 and the electro-optical panel-side capacitance CLCD are referred to as capacitance other than the capacitor circuit 10. The capacitance value of the variable capacitance circuit 30 is adjusted so that an appropriate data voltage is written to a pixel at least during the pixel driving. Assuming that the capacitance value of the variable capacitance circuit 30 is constant among the operation states, since the electro-optical panel-side capacitance CLCD changes according to the operation state, the capacitance other than the capacitor circuit 10 also changes. Then, the distribution ratio between the capacitor circuit 10 and the capacitance other than the capacitor circuit 10 varies. As a result, an appropriate voltage cannot be generated during the precharge and the post charge.

In the present embodiment, the control circuit 40 controls the capacitance value of the variable capacitance circuit 30 so that the capacitance other than the capacitor circuit 10 is constant among the precharge, the pixel driving, and the post charge.

The control circuit 40 sets the adjustment switches SWA1 to SWA5 of the variable capacitance circuit 30 to a connection state 1 during the precharge. The connection state 1 is a state in which the variable capacitance circuit 30 is set to a capacitance value CA(0). The number in ( ) of CA(0) indicates the number of data lines corresponding to the capacitance value. CA(0) is a capacitance value corresponding to 0 data lines and is, for example, 0 pF. Still, CA(0)>0 pF may hold as offset. The capacitance other than the capacitor circuit 10 is CP+8CL+CA(0).

The control circuit 40 sets the adjustment switches SWA1 to SWA5 of the variable capacitance circuit 30 to a connection state 2 during the pixel driving. The connection state 2 is a state in which the variable capacitance circuit 30 is set to a capacitance value CA(7). CA(7) is a capacitance value corresponding to seven data lines, and CA(0)+7CL holds. Still, CA(7) does not need to be exactly equal to CA(0)+7CL, and may be substantially equal to CA(0)+7CL. The capacitance other than the capacitor circuit 10 is CP+CL+CA(7)≈CP+8CL+CA(0).

The control circuit 40 sets the adjustment switches SWA1 to SWA5 of the variable capacitance circuit 30 to a connection state 3 during the post charge. The connection state 3 is a state in which the variable capacitance circuit 30 is set to a capacitance value CA(8). CA(8) is a capacitance value corresponding to eight data lines, and CA(0)+8CL holds. Still, CA(8) does not need to be exactly equal to CA(0)+8CL, and may be substantially equal to CA(0)+8CL. The capacitance other than the capacitor circuit 10 is CP+CA(8)≈CP+8CL+CA(0).

As described above, the capacitance other than the capacitor circuit 10 is CP+8CL+CA(0) and is constant among the operation states.

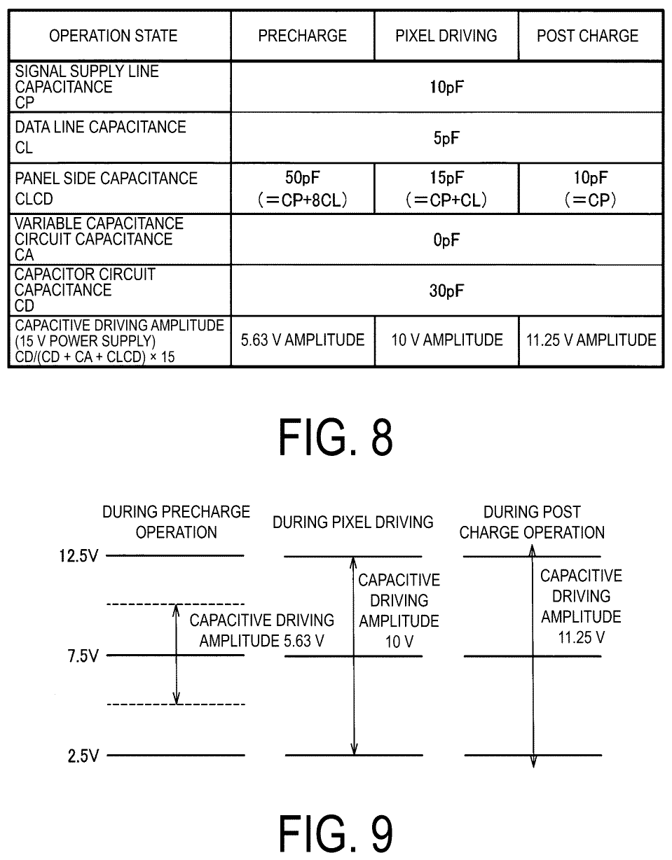

FIGS. 8 and 9 illustrate specific examples of the capacitive driving amplitude achieved with the capacitance value of the variable capacitance circuit being constant among the operation states. Here, it is assumed that the capacitive driving amplitude during the pixel driving is 10 V which is achieved when the capacitance value of the variable capacitance circuit 30 is 0 pF.

It is assumed that the capacitance value CP of the signal supply line is 10 pF and the capacitance value CL of one data line is 5 pF. Under such an assumption, the electro-optical panel-side capacitance CLCD is CP+8CL=50 pF during the precharge, CP+CL=15 pF during the pixel driving, and CP=10 pF during the post charge.

When the voltage VDH of the high potential side power supply is 15 V, the capacitive driving amplitude is CD/(CD+CA+CLCD)×15 V. When the capacitive driving amplitude during the pixel driving is 10 V, CD/(CD+15 pF)×15 V=10 V holds, and CD=30 pF holds. Thus, the total capacitance CD of the capacitor circuit 10 for achieving the capacitive driving amplitude of 10 V is 30 pF.

When the capacitance value CA of the variable capacitance circuit 30 does not change from 0 pF, the capacitance CA+CLCD other than the capacitor circuit 10 is 50 pF during the precharge, 15 pF during the pixel driving, and 10 pF during the post charge. Therefore, the capacitive driving amplitude is 5.63 V during the precharge, 10 V during the pixel driving, and 11.25 V during the post charge.

For example, the lowest voltage 2.5 V of the voltage range is used for the precharge for reducing pixel leakage. However, since the capacitive driving amplitude is only 5.63 V, only a decrease to 4.69 V is achievable even when it is attempted to output 2.5 V. Thus, the effect of the precharge may be compromised, resulting in a degraded image quality. Similarly, with the post charge, a target voltage may fail to be output.

When the amplifier circuit described above is added, an error in the precharge voltage can be eliminated by the amplifier circuit, and the precharge voltage of 2.5 V can be output. However, for this purpose, the amplifier circuit needs to charge the capacitance of 50 pF+30 pF. This requires a high current supplying capability, leading to a large power consumption of the amplifier circuit.

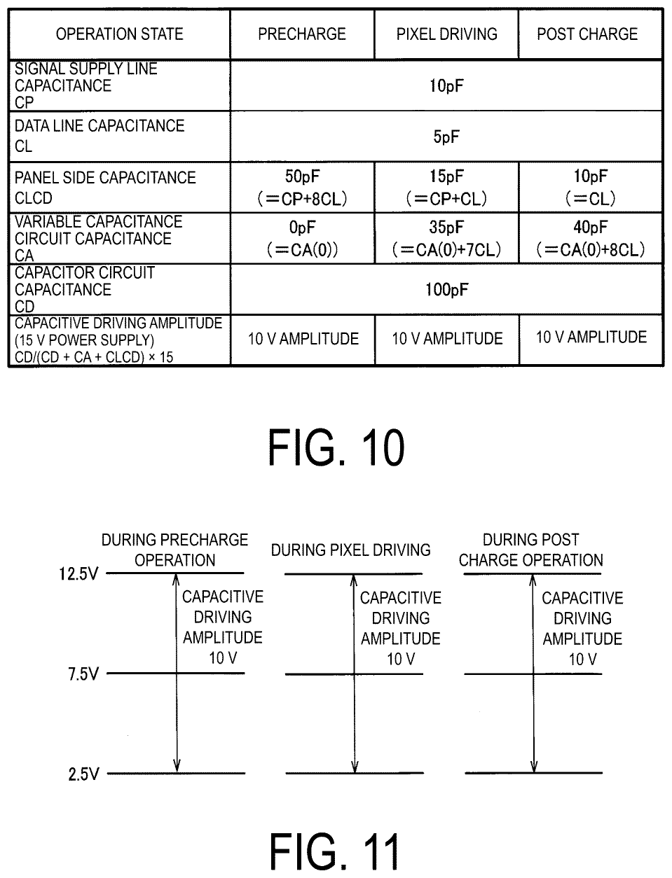

FIGS. 10 and 11 illustrate specific examples of the capacitive driving amplitude achieved with the capacitance value of the variable capacitance circuit changed according to the operation state. It is assumed that the signal supply line capacitance CP=10 pF, the data line capacitance CL=5 pF, the high potential side power supply voltage VDH=15 V, and the capacitive driving amplitude is 10 V during the pixel driving, as in FIG. 8.

The capacitance value of the variable capacitance circuit 30 during the precharge is assumed to be CA(0)=0 pF. Under such an assumption, the capacitance CA+CLCD other than the capacitor circuit 10 is 50 pF. Since the capacitance value CA of the variable capacitance circuit 30 is controlled to achieve a constant capacitance CA+CLCD, 50 pF−15 pF=35 pF holds during the pixel driving and 50 pF−40 pF=10 pF holds during the post charge.

As described above, the capacitive driving amplitude is CD/(CD+CA+CLCD)×15 V. The total capacitance of the capacitor circuit 10 achieving the capacitive driving amplitude 10 V is from CD/(CD+50 pF)×15 V=10 V to CD=100 pF. Since CA+CLCD is constant among the operation states, the capacitive driving amplitude is constant at the 10 V among the precharge, the pixel driving, and the post charge.

When the amplifier circuit described above is added, the precharge voltage with no or extremely small error can be achieved. The amplifier circuit is required to charge the capacitance of 50 pF+100 pF, but only needs to have a low current supplying capability because the error in the capacitive driving voltage is small. Thus, the power consumption of the amplifier circuit can be made small.

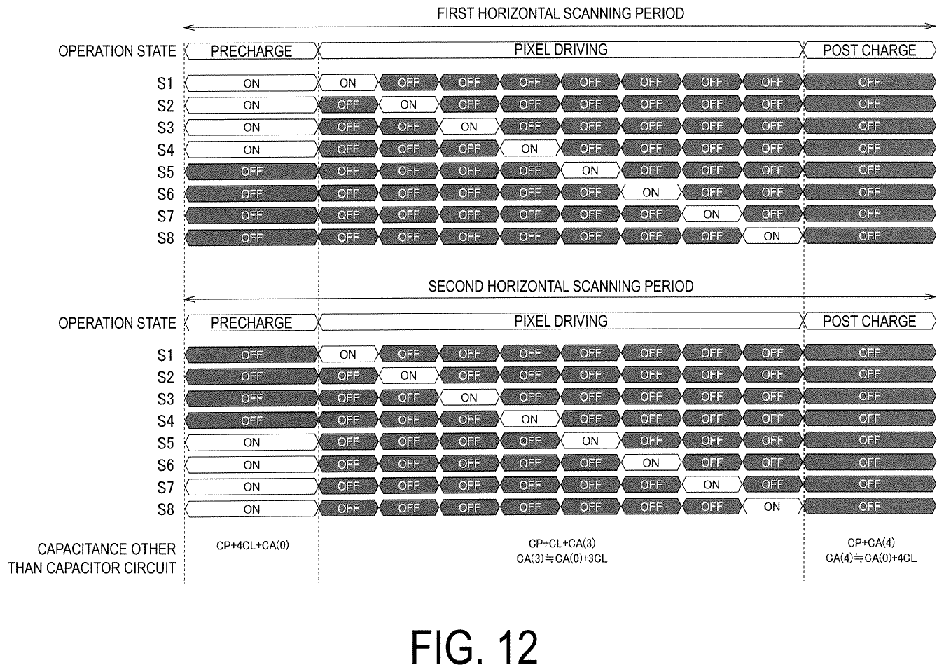

Although an example in which all the data lines are precharged in each horizontal scanning period has been described above, the precharge may be performed in a divided manner for a plurality of horizontal scanning periods. Such precharge is referred to as divided precharge. FIG. 12 is a diagram for explaining control on the variable capacitance circuit in each operation state in a case where the divided precharge is performed. While an example in which the divided precharge is performed in two horizontal scanning periods will be described below, the divided precharge may be performed in three or more horizontal scanning periods.

The following control is performed in a first horizontal scanning period. During the precharge, the control circuit 40 outputs the control signals S1 to S4 indicating ON, and outputs the control signals S5 to S8 indicating OFF. Accordingly, the electro-optical panel-side capacitance CLCD=CP+4CL holds. The control circuit 40 sets the variable capacitance circuit 30 to the capacitance value CA(0). During the pixel driving, the control circuit 40 sequentially outputs control signals S1, S2, . . . , S8 indicating ON. Accordingly, the electro-optical panel-side capacitance CLCD=CP+CL holds. The control circuit 40 sets the variable capacitance circuit 30 to a capacitance value CA(3). CA(3)≈CA(0)+3CL holds. During the post charge, the control circuit 40 outputs the control signals S1 to S8 indicating OFF. Thus, in the electro-optical device 400, CLCD=CP holds. The control circuit 40 sets the variable capacitance circuit 30 to a capacitance value CA(4). CA(4)≈CA(0)+4CL holds.

The following control is performed in a second horizontal scanning period. During the precharge, the control circuit 40 outputs the control signals S1 to S4 indicating OFF, and outputs the control signals S5 to S8 indicating ON. The capacitance values of the electro-optical panel-side capacitance CLCD and the variable capacitance circuit 30 are the same as those in the first horizontal scanning period. Control during the pixel driving and the post charge is also the same as that in the first horizontal scanning period. Thereafter, a horizontal scanning period similar to the first horizontal scanning period and a horizontal scanning period similar to the second horizontal scanning period are alternately repeated.

As described above, the electro-optical panel-side capacitance CLCD is constant at CP+4CL+CA(0) among the operation states.

In the present embodiment, the driver 100 includes the capacitor driving circuit 20, the variable capacitance circuit 30, and the control circuit 40. The capacitor driving circuit 20 outputs the first to n-th capacitor driving voltages corresponding to grayscale data DTH[n−1:0] to first to n-th capacitor driving nodes NDR1 to NDRn. The capacitor circuit 10 includes first to n-th capacitors CA1 to CAn provided between the first to n-th capacitor driving nodes NDR1 to NDRn and the output terminal TQj. The variable capacitance circuit 30 is connected to the output terminal TQj. The control circuit 40 sets the variable capacitance circuit 30 to the first capacitance value CA(7) in a driving period of the pixel 1 of the electro-optical panel 200, and sets the variable capacitance circuit 30 to the second capacitance value CA(0) smaller than the first capacitance value CA(7) in a precharge period of the electro-optical panel 200.

As described above with reference to FIG. 7 and the like, the electro-optical panel-side capacitance CLCD during the precharge period is larger than the electro-optical panel-side capacitance CLCD during the driving period of the pixel 1. According to the present embodiment, the control circuit 40 sets the variable capacitance circuit 30 to the first capacitance value CA(7) in the driving period of the pixel 1, and sets the variable capacitance circuit 30 to the second capacitance value CA(0) smaller than the first capacitance value CA(7) in the precharge period. Accordingly, the capacitance CA+CLCD other than the capacitor circuit 10 in the driving period of the pixel 1 and the capacitance CA+CLCD other than the capacitor circuit 10 in the precharge period can be made close to each other, compared with a case where the capacitance value of the variable capacitance circuit 30 is fixed. As a result, an appropriate capacitive driving amplitude can be obtained even during the precharge, and a precharge voltage with high accuracy can be applied to the data line.

In the present embodiment, the capacitance value of the variable capacitance circuit 30 is defined as CA, and the capacitance value of the electro-optical panel-side capacitance is defined as CLCD. Under this condition, the control circuit 40 sets the first capacitance value CA(7) and the second capacitance value CA(0) to obtain CA+CLCD in the precharge period close to CA+CLCD in the driving period of the pixel 1.

By setting the capacitance value of the variable capacitance circuit 30 in this manner, the capacitance CA+CLCD other than the capacitor circuit 10 in the precharge period can be brought close to the capacitance CA+CLCD other than the capacitor circuit 10 in the driving period of the pixel 1.

In addition, in the present embodiment, the control circuit 40 sets the first capacitance value CA(7) and the second capacitance value CA(0) such that CA+CLCD in the driving period of the pixel 1 and CA+CLCD in the precharge period are constant.

By setting the capacitance value of the variable capacitance circuit 30 in this manner, the capacitance CA+CLCD other than the capacitor circuit 10 in the precharge period can be made equal to the capacitance CA+CLCD other than the capacitor circuit 10 in the driving period of the pixel 1. Thus, the capacitive driving amplitude in the precharge period can be made equal to the capacitive driving amplitude in the driving period of the pixel 1.

In the present embodiment, the variable capacitance circuit 30 includes first to m-th adjustment capacitors CA1 to CAm, and first to m-th adjustment switches SWA1 to SWAm provided between the first to m-th adjustment capacitors CA1 to CAm and the output terminal TQj.

According to the present embodiment, the control circuit 40 changes the ON/OFF states of the first to m-th adjustment switches SWA1 to SWAm in accordance with the operation state, and thus it is possible to change the capacitance value of the variable capacitance circuit 30 in accordance with the operation state.

In the present embodiment, the control circuit 40 sets the variable capacitance circuit 30 to a third capacitance value CA(8) larger than the first capacitance value CA(7) in the post charge period.

As described with reference to FIG. 7 and the like, the electro-optical panel-side capacitance CLCD during the post charge period is smaller than the electro-optical panel-side capacitance CLCD during the driving period of the pixel 1. According to the present embodiment, the control circuit 40 sets the variable capacitance circuit 30 to the first capacitance value CA(7) in the driving period of the pixel 1, and sets the variable capacitance circuit 30 to the third capacitance value CA(8) greater than the first capacitance value CA(7) in the post charge period. Accordingly, the capacitance CA+CLCD other than the capacitor circuit 10 in the driving period of the pixel 1 and the capacitance CA+CLCD other than the capacitor circuit 10 in the post charge period can be made close to each other, compared with a case where the capacitance value of the variable capacitance circuit 30 is fixed. As a result, an appropriate capacitive driving amplitude can be obtained even during the post charge, and a post charge voltage with high accuracy can be applied to the data line.

In the present embodiment, the electro-optical device 400 includes the driver 100 and the electro-optical panel 200. The electro-optical panel 200 includes the signal supply line SLj, the first to p-th switches SWj1 to SWjp whose one ends are connected to the signal supply line SLj, and the first to p-th data lines DLj1 to DLjp connected to the other ends of the first to p-th switches SWj1 to SWjp.

As described above with reference to FIG. 12, first to p/2-th switches among the first to p-th switches SWj1 to SWjp may be ON in the precharge period of the first horizontal scanning period. In the precharge period of the second horizontal scanning period, p/2+1-th to p-th switches among the first to p-th switches SWj1 to SWjp may be ON.

In the present embodiment, the capacitance value of the variable capacitance circuit 30 is set such that the capacitance CA+CLCD other than the capacitor circuit 10 in the pixel driving period and the capacitance CA+CLCD other than the capacitor circuit 10 in the precharge period are constant. With this configuration, even when the divided precharge is performed, an appropriate capacitive driving amplitude can be obtained also during the precharge, and a precharge voltage with high accuracy can be applied to the data line.

### 4. Electronic Apparatus

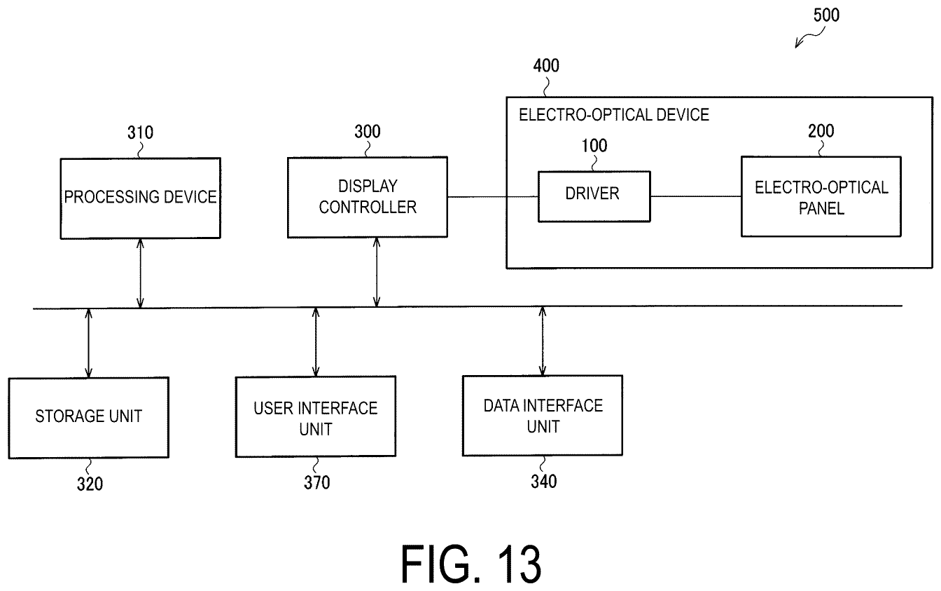

FIG. 13 is a configuration example of an electronic apparatus including the driver of the present embodiment. Various electronic apparatus on which display devices are mounted can be contemplated as the electronic apparatus of the present embodiment. For example, the electronic apparatus is a projector, a television device, an information processing device, a personal digital assistant, a car navigation system, a portable game terminal, or the like.

An electronic apparatus 500 includes the electro-optical device 400, the display controller 300, a processing device 310, a storage unit 320, a user interface unit 330, and a data interface unit 340. The electro-optical device 400 includes the driver 100 and the electro-optical panel 200.

The user interface unit 330 is an interface unit for receiving various operations from a user. For example, the user interface unit 330 includes a button, a mouse, a keyboard, a touch panel mounted to the electro-optical panel 200, or the like. The data interface unit 340 is an interface unit for inputting and outputting image data or control data. For example, the data interface unit 340 is a wired communication interface such as a USB or a wireless communication interface such as a wireless LAN. The storage unit 320 stores image data input from the data interface unit 340. Alternatively, the storage unit 320 serves as a working memory for the processing device 310 or the display controller 300. The processing device 310 performs control processing for the units in the electronic apparatus and various data processing. The processing device 310 is, for example, a processor, such as a CPU or a microcomputer. The display controller 300 executes control processing for the driver 100. For example, the display controller 300 converts image data transferred from the data interface unit 340 or the storage unit 320 into a format receivable in the driver 100, and outputs the converted image data to the driver 100. The driver 100 drives the electro-optical panel 200 based on the image data transferred from the display controller 300.

Although the present embodiment has been described in detail above, those skilled in the art will easily understand that many modified examples can be made without substantially departing from novel items and effects of the present disclosure. All such modified examples are thus included in the scope of the present disclosure. For example, terms in the descriptions or drawings given even once along with different terms having identical or broader meanings can be replaced with those different terms in all parts of the descriptions or drawings. All combinations of the present embodiment and modified examples are also included within the scope of the present disclosure. The configurations, the operations, and the like of the control circuit, the output circuit, the driver, the electro-optical panel, the electro-optical device, and the electronic apparatus are not limited to those described in the present embodiment, and various modifications can be achieved.

What is claimed is:

1. A driver comprising:
a capacitor driving circuit configured to output first to n-th capacitor driving voltages, corresponding to grayscale data to first to n-th capacitor driving nodes, n being a natural number equal to or larger than 2;
a capacitor circuit including first to n-th capacitors provided between the first to n-th capacitor driving nodes and an output terminal;
a variable capacitance circuit connected to the output terminal; and
a control circuit configured to set the variable capacitance circuit to a first capacitance value in a pixel driving period of an electro-optical panel and to set the variable capacitance circuit to a second capacitance value smaller than the first capacitance value in a precharge period of the electro-optical panel.

2. The driver according to claim 1, wherein
the control circuit sets the first capacitance value and the second capacitance value to make CA+CLCD in the precharge period close to CA+CLCD in the pixel driving period, where
CA is a capacitance value of the variable capacitance circuit and CLCD is a capacitance value of a side of the electro-optical panel-side capacitance.

3. The driver according to claim 1, wherein
the control circuit sets the first capacitance value and the second capacitance value to make CA+CLCD in the pixel driving period and CA+CLCD in the precharge period constant, where
CA is a capacitance value of the variable capacitance circuit and CLCD is a capacitance value of a side of the electro-optical panel-side capacitance.

4. The driver according to claim 1, wherein
the variable capacitance circuit includes:
first to m-th adjustment capacitors, m being a natural number equal to greater than 2; and
first to m-th adjustment switches provided between the first to m-th adjustment capacitors and the output terminal.

5. The driver according to claim 1, wherein the control circuit sets the variable capacitance circuit to a third capacitance value larger than the first capacitance value in a post charge period.

6. An electro-optical device comprising:
the driver according to claim 1, and
the electro-optical panel, wherein
the electro-optical panel includes:
a signal supply line;
first to p-th switches having one ends connected to the signal supply line, p being an integer that is equal to or larger than 2; and
first to p-th data lines connected to other ends of the first to p-th switches.

7. The electro-optical device according to claim 6, wherein
the first to p-th switches are ON in the precharge period, and
any one of the first to p-th switches is ON in the pixel driving period.

8. The electro-optical device according to claim 6, wherein
first to p/2-th switches among the first to p-th switches are ON in the precharge period of a first horizontal scanning period, p being an even number equal to or larger than 2, and
p/2+1-th to p-th switches among the first to p-th switches are ON in the precharge period of a second horizontal scanning period.

9. An electronic apparatus comprising:
the driver according to claim 1.
